(19) United States
(12) Patent Application Publication
(10) Pub. No.: US 2026/0162529 A1
(43) Pub. Date: Jun. 11, 2026

(54) VEHICULAR SYSTEM AND METHOD FOR NOTIFYING A VEHICLE OCCUPANT OF A NEARBY EMERGENCY VEHICLE

(71) Applicants: Ningbo Geely Automobile Research & Development Co., Ltd., Ningbo (CN); Zhejiang Geely Holding Group Co., Ltd., Zhejiang (CN)

(72) Inventors: Erik LINDBERG NILSSON, Göteborg (SE); Magnus NILSSON, Floda (SE)

(21) Appl. No.: 19/178,732

(22) Filed: Apr. 14, 2025

Related U.S. Application Data
(63) Continuation of application No. PCT/CN2023/124558, filed on Oct. 13, 2023.

(30) Foreign Application Priority Data
Oct. 17, 2022 (EP) 22201827

(51) Int. Cl. G08G 1/0965; G08B 21/18

(52) U.S. Cl. CPC G08G 1/0965; G08B 21/182

(57) ABSTRACT

A vehicular system for notifying a vehicle occupant of a vehicle of a nearby emergency vehicle, the system includes: a surrounding information detection sensor configured to obtain surrounding information data of the surrounding of the vehicle and the vehicle occupant; and a processing circuitry configured to obtain surrounding information data of the surrounding of the vehicle and the vehicle occupant, detect, based on the obtained surrounding information data, an emergency vehicle in the vicinity of the vehicle, determine a notification value based on the obtained surrounding information data, and in a determination that the notification value is above a predefined threshold level notify the vehicle occupant of the emergency vehicle.

### RELATED APPLICATION DATA

This application is a continuation of International Patent Application No. PCT/CN 2023/124558, filed Oct. 13, 2023, and claims the benefit of European Patent Application No. 22201827.7, filed Oct. 17, 2022, the disclosures of which are incorporated herein by reference in their entireties.

### TECHNICAL FIELD

The present disclosure relates to a method, a vehicular system and a computer program product for notifying a vehicle occupant of a vehicle of a nearby emergency vehicle.

### BACKGROUND

Emergency vehicles often make use of flashing lights and siren sounds in order to make it easier for vehicle occupants in surrounding vehicles to detect the emergency vehicle in order to give way and leave space for the emergency vehicle in due time, in a controlled and calm way.

However, in a situation where e.g. there are lot of traffic and other things going on in the surrounding of the vehicle occupant, it can sometimes be hard to notice an approaching emergency vehicle, or it can be difficult to notice where the approaching emergency vehicle is and understand if there is a need to leave space for it.

Not noticing the approaching emergency vehicle in time, or not noticing the approaching emergency vehicle at all, can lead to an undesirable situation for both the vehicle occupant and for the emergency vehicle.

There is therefore a desire to make the vehicle occupant of a vehicle aware of a nearby emergency vehicle.

### SUMMARY

It is an object of the present disclosure to mitigate, alleviate or eliminate one or more of the above-identified deficiencies and disadvantages in the prior art and solve at least the above mentioned problem.

According to a first aspect there is provided a vehicular system for notifying a vehicle occupant of a vehicle of a nearby emergency vehicle.

The system comprises a surrounding information detection sensor configured to obtain surrounding information data of the surrounding of the vehicle and the vehicle occupant.

The system further comprises a processing circuitry configured to obtain surrounding information data of the surrounding of the vehicle and the vehicle occupant.

The processing circuitry is further configured to detect, based on the obtained surrounding information data, an emergency vehicle in the vicinity of the vehicle.

The processing circuitry is further configured to determine a notification value based on the obtained surrounding information data, and in a determination that the notification value is above a predefined threshold level, notify the vehicle occupant of the emergency vehicle.

One advantage with this first aspect is that the vehicular system can be used for supporting the vehicle occupant to become aware of a nearby emergency vehicle when it is determined that the there is a need to notify the vehicle occupant of the emergency vehicle.

According to some embodiments, the surrounding information data is at least any of sound data, image data, map data, traffic information data, population density data, road information data, emergency vehicle detection data and weather information data.

One advantage with this embodiment is that different surrounding information data can be used for determining when to notify the vehicle occupant of the emergency vehicle.

According to some embodiments, the obtained surrounding information data is indicative of that the vehicle is in a city environment and setting the notification value to a value that is above the predefined threshold level.

One advantage with this embodiment is that if the vehicle is in a city environment the vehicle occupant will be notified of the emergency vehicle.

According to some embodiments, the obtained surrounding information data is indicative of that the emergency vehicle is not visible to the vehicle occupant of the vehicle and setting the notification value to a value that is above the predefined threshold level.

One advantage with this embodiment is that when it is determined that the emergency vehicle cannot be observed by the vehicle occupant, the vehicle occupant will be notified of the emergency vehicle.

According to some embodiments, the notification value is correlated with a cognitive load value, and wherein the processing circuitry is further configured to determine a cognitive load value based on the obtained surrounding information data, wherein the cognitive load value is indicative of if the obtained surrounding information data is determined to have an impact on the perceptiveness of the vehicle occupant, and in a determination that the cognitive load value is above a predefined threshold level set the notification value to a value that is above the predefined threshold level.

One advantage with this embodiment is that when it is determined that the perceptiveness of the vehicle occupant is affected, the vehicle occupant will be notified of the emergency vehicle.

According to some embodiments, the cognitive load value is determined based on surrounding information data of the surrounding external and/or internal to the vehicle.

One advantage with this embodiment is that surrounding information data of the surrounding external to the vehicle, e.g. heavy traffic, many pedestrians, and/or internal to the vehicle, e.g. noise inside of the vehicle, can be used to determine the cognitive load value.

According to some embodiments, the system further comprises an output interface for notifying the vehicle occupant of the emergency vehicle in the vicinity if the vehicle, wherein the output interface is any of a display output interface, a sound output interface, a tactile output interface, a light output interface.

One advantage with this embodiment is that the vehicle occupant can see, feel and/or hear the notification.

According to some embodiments, the processing circuitry is further configured to notify the vehicle occupant by a directional information notification indicative of a direction to the emergency vehicle in relation to the vehicle.

One advantage with this embodiment is that the vehicle occupant get support with finding the direction where the emergency vehicle can be found.

According to a second aspect there is provided a method for notifying a vehicle occupant of a nearby emergency vehicle.

The method comprising the step of obtaining surrounding information data of the surrounding of the vehicle and the vehicle occupant.

The method further comprising the step of detecting, based on the obtained surrounding information data, an emergency vehicle in the vicinity of the vehicle.

The method further comprising the step of determining a notification value based on the obtained surrounding information data, and in a determination that the notification value is above a predefined threshold level notifying the vehicle occupant of the emergency vehicle.

One advantage with this second aspect is that the vehicular system can be used for supporting the vehicle occupant to become aware of a nearby emergency vehicle when it is determined that the there is a need to notify the vehicle occupant of the emergency vehicle.

According to some embodiments, wherein the surrounding information data is at least any of sound data, image data, map data, traffic information data, population density data, road information data and weather information data.

One advantage with this embodiment is that different surrounding information data can be used for determining when to notify the vehicle occupant of the emergency vehicle.

According to some embodiments, the obtained surrounding information data is indicative of that the vehicle is in a city environment and setting the notification value to a value that is above the predefined threshold level.

One advantage with this embodiment is that if the vehicle is in a city environment the vehicle occupant will be notified of the emergency vehicle.

According to some embodiments, the obtained surrounding information data is indicative of that emergency vehicle is not visible to the vehicle occupant of the vehicle and setting the notification value to a value that is above the predefined threshold level.

One advantage with this embodiment is that when it is determined that the emergency vehicle cannot be observed by the vehicle occupant, the vehicle occupant will be notified of the emergency vehicle.

According to some embodiments, wherein the notification value is correlated with a cognitive load value, and the method further comprises determining a cognitive load value based on the obtained surrounding information data, wherein the cognitive load value is indicative of if the obtained surrounding information data is determined to have an impact on the perceptiveness of the vehicle occupant, and in a determination that the cognitive load value is above a predefined threshold level setting the notification value to a value that is above the predefined threshold level.

One advantage with this embodiment is that when it is determined that the perceptiveness of the vehicle occupant is affected, the vehicle occupant will be notified of the emergency vehicle.

According to some embodiments, the method further comprises notifying the vehicle occupant by a directional information notification indicative of a direction to the emergency vehicle in relation to the vehicle.

One advantage with this embodiment is that the vehicle occupant get support with finding the direction where the emergency vehicle can be found.

According to a third aspect there is provided a computer program product comprising a non-transitory computer readable medium, having thereon a computer program comprising program instructions, the computer program being loadable into a processing circuitry and configured to cause execution of the method when the computer program is run by the processing circuitry.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 illustrates an example vehicular system for notifying a vehicle occupant of a vehicle of a nearby emergency vehicle according to an embodiment of the present disclosure.

FIG. 2A illustrates an example wherein the surrounding information detection sensor is a camera and the surrounding information data is image data.

FIG. 2B illustrates an example wherein the surrounding information detection sensor is a wireless communication interface and the surrounding information data is at least any of map data, traffic information data, population density data, road information data, emergency vehicle detection data and weather information data.

FIG. 3 illustrates a flow chart of the method steps according to the second aspect of the disclosure.

FIG. 4 illustrates a computer program product according to the third aspect of the disclosure.

### DETAILED DESCRIPTION OF EXAMPLE EMBODIMENTS

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

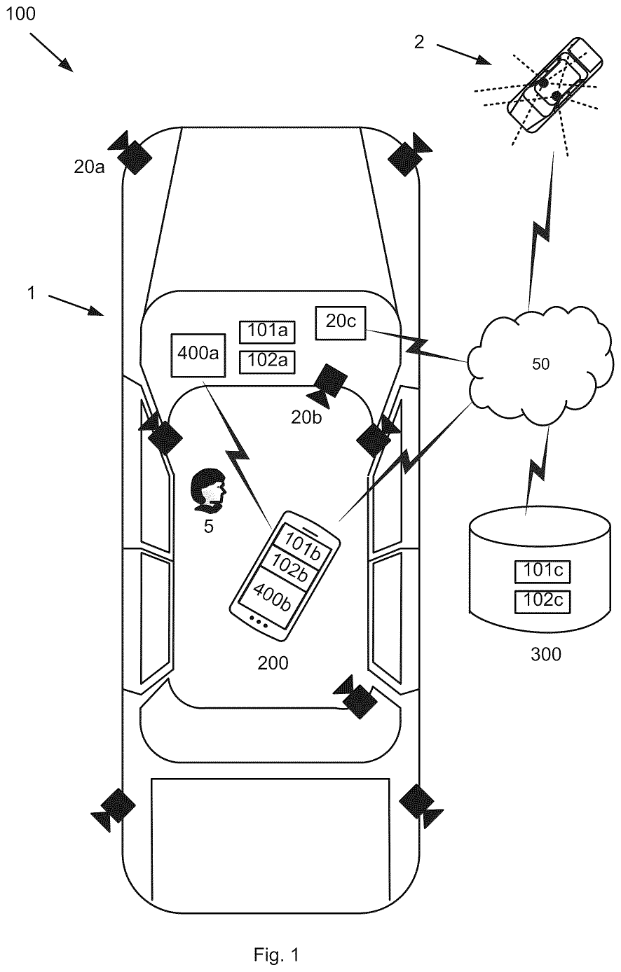

FIG. 1 illustrates an example vehicular system for notifying a vehicle occupant of a vehicle of a nearby emergency vehicle according to an embodiment of the present disclosure.

The first aspect of this disclosure shows a vehicular system 100 for notifying a vehicle occupant 5 of a vehicle 1 of a nearby emergency vehicle 2.

The system 100 comprises a surrounding information detection sensor 20a, 20b, 20c.

According to some embodiments, the surrounding information detection sensor 20a, 20b, 20c is at least any of a camera sensor 20a, 20b, a LIDAR sensor, a RADAR sensor, a sonar sensor, a microphone, and a wireless communication interface 20c.

FIG. 1 illustrates an example vehicular system 100 with plural surrounding information detection sensors. In the example vehicular system 100 illustrated in FIG. 1 the surrounding information detection sensors are one external camera sensor 20a, one internal camera sensor 20b and one wireless communication interface 20c.

The surrounding information detection sensor 20a, 20b, 20c is configured to obtain surrounding information data of the surrounding of the vehicle 1 and the vehicle occupant 5.

The system 100 comprises a processing circuitry 102a, 102b, 102c configured to obtain surrounding information data of the surrounding of the vehicle 1 and the vehicle occupant 5.

The processing circuitry 102a, 102b, 102c is further configured to detect, based on the obtained surrounding information data, an emergency vehicle 2 in the vicinity of the vehicle 1.

According to some embodiments the surrounding information detection sensor 20a, 20b, 20c is operatively connectable to the processing circuitry 102a, 102b, 102c.

According to some embodiments the processing circuitry 102a is the processing circuitry of an on-board vehicle computer, as illustrated in FIG. 1

According to some embodiments the processing circuitry 102b, 102c is comprised in an electronic device 200, 300 connectable to the vehicular system 100 via a wireless communication network 50, as illustrated in FIG. 1.

According to some embodiments the vehicular system 100 further comprises a memory 101a, 101b, 101c configured to store data.

According to some embodiments the memory 101a is the memory of an on-board vehicle computer, as illustrated in FIG. 1. According to some embodiments the memory 101b, 101c is comprised in an electronic device 200, 300 connectable to the vehicular system 100 via the wireless communication network 50, as illustrated in FIG. 1.

According to some embodiments the wireless communication network 50, as illustrated in FIG. 1, is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network.

According to some embodiments the wireless communication network 50 is a standardized wireless local area network such as a Wireless Local Area Network, WLAN, Bluetooth™, ZigBee, Ultra-Wideband, Radio Frequency Identification, RFID, or similar network.

According to some embodiments wireless communication network 50 can also be a combination of both a local area network and a wide area network.

According to some embodiments the wireless communication network 50 is defined by common Internet Protocols.

According to some embodiments the emergency vehicle 2 is detected by analysis of the obtained surrounding information data.

According to some embodiments the emergency vehicle 2 is detected by sound analysis of the obtained sound data. According to some embodiments the sound data is analyzed by comparing the obtained sound data with predetermined sound data of emergency vehicles. In an example, predetermined frequencies of siren sounds of emergency vehicles are used for detecting the emergency vehicle 2.

According to some embodiments the emergency vehicle 2 is detected by image analysis of the obtained image data. According to some embodiments the image data is analyzed by comparing the obtained image data with predetermined image data of emergency vehicles. In an example, predetermined models and colors of emergency vehicles are pre-identified and used for detecting the emergency vehicle 2.

According to some embodiments the emergency vehicle 2 is detected by analysis of the obtained traffic information data.

According to some embodiments the traffic information data is analyzed by determining the speed and driving pattern of vehicles in the obtained traffic information data to determine if a vehicle travels with a faster speed and/or with a driving pattern that stands out from the other vehicles. In an example, a vehicle that is travelling with a higher speed and changing lanes more often that other vehicles can be interpreted as an emergency vehicle 2.

According to some embodiments the traffic information data is obtained via a wireless communication interface 20c.

According to some embodiments the emergency vehicle 2 is detected by analysis of the obtained emergency vehicle detection data.

According to some embodiments the emergency vehicle detection data comprises at least any of identity information of an emergency vehicle, the current geographical position and/or direction of the emergency vehicle 2, the destination of the emergency vehicle 2, the planned route of the emergency vehicle 2, alternative routes of the emergency vehicle 2, and the speed of the emergency vehicle 2.

According to some embodiments the emergency vehicle detection data is obtained via a wireless communication interface 20c.

According to some embodiments the wireless communication interface 20c is communicating with a wireless communication network 50 that is connected to a communication system such a vehicle-to-vehicle, V2V, a vehicle-to-everything V2X, or a vehicle-to-Infrastructure, V2I, communication system.

According to some embodiments the processing circuitry 102a, 102b, 102c is further configured to detect, based on the obtained surrounding information data, a direction to the detected emergency vehicle 2 in relation to the vehicle 1.

According to some embodiments sound data is used for detecting the direction to the detected emergency vehicle 2 in relation to the vehicle 1. According to some embodiments the surrounding information detection sensor 20a, 20b, 20c is a sonar sensor configured to determine a direction of the obtained sound data.

According to some embodiments image data is used for detecting the direction to the detected emergency vehicle 2 in relation to the vehicle 1. According to some embodiments the surrounding information detection sensor 20a, 20b, 20c is a camera sensor configured to determine a direction of the obtained image data.

According to some embodiments detecting the emergency vehicle 2 in the vicinity of the vehicle 1 further comprising detecting the direction to the detected emergency vehicle 2 in relation to the vehicle 1.

The processing circuitry 102a, 102b, 102c is further configured to determine a notification value based on the obtained surrounding information data, and in a determination that the notification value is above a predefined threshold level notify the vehicle occupant 5 of the emergency vehicle 2.

According to some embodiments, the notification value is based on plural different surrounding information data.

According to some embodiments, the notification value is a sum of a function equation that is dependent on plural different surrounding information data.

According to some embodiments, different surrounding information data can be given different weight in the function equation that is dependent on plural different surrounding information data.

One advantage with this first aspect is that the vehicular system can be used for supporting the vehicle occupant to become aware of a nearby emergency vehicle when it is determined that the there is a need to notify the vehicle occupant of the emergency vehicle.

According to some embodiments the surrounding information data is at least any of sound data, image data, map data, traffic information data, population density data, road information data, emergency vehicle detection data and weather information data.

According to some embodiments the notification value is a sum of a function equation that is dependent on plural different surrounding information data, and the different surrounding information data is at least two of sound data, image data, map data, traffic information data, population density data, road information data, emergency vehicle detection data and weather information data.

In an example the notification value is determined based on emergency vehicle detection data and weather information data.

In an example the emergency vehicle detection data is used for detecting that the emergency vehicle on the same road as the vehicle 1 which results in a certain notification value, and further the weather information data is indicative of heavy rain which results in another certain notification value, and the notification value, that is a sum of a function equation that is dependent on plural different surrounding information data is determined to be above the predefined threshold level. The vehicle occupant is hence notified by the system 100.

In an example the emergency vehicle detection data is used for detecting that the emergency vehicle is not on the same road as the vehicle 1 which results in a certain notification value, and further the weather information data is indicative of clear blue sky and sunshine which results in another certain notification value, and the notification value, that is a sum of a function equation that is dependent on plural different surrounding information data is determined to be below the predefined threshold level. The vehicle occupant is hence not notified by the system 100.

One advantage with this embodiment is that different surrounding information data can be used for determining when to notify the vehicle occupant of the emergency vehicle.

According to some embodiments the obtained surrounding information data is indicative of that the vehicle 1 is in a city environment and setting the notification value to a value that is above the predefined threshold level.

According to some embodiments the determination that the vehicle 1 is in a city environment is determined based on that the obtained surrounding information data is at least any of map data and population density data. In an example it is determined that the vehicle 1 is at a geographical location that is within boundaries of a city.

According to some embodiments the determination that the vehicle 1 is in a city environment is determined based on that the obtained surrounding information data is image data. In an example image processing is used to determine that objects in the image data are indicative of objects of a city.

In a city it is generally more information in the surroundings that the vehicle occupant needs to pay attention to compare to when the vehicle occupant is in a rural area.

One advantage with this embodiment is that if the vehicle is in a city environment the vehicle occupant will be notified of the emergency vehicle.

According to some embodiments the obtained surrounding information data is indicative of that the emergency vehicle 2 is not visible to the vehicle occupant 5 of the vehicle 1 and setting the notification value to a value that is above the predefined threshold level.

According to some embodiments, the surrounding information data is image data obtained by a camera 20a.

According to some embodiments the camera 20a is arranged at a predetermined location at the vehicle 1.

According to some embodiments the camera 20a is arranged at a predetermined location at the vehicle 1 in relation to the vehicle occupant in the vehicle 1.

According to some embodiments by processing of the image data it can be determined what the vehicle occupant can possibly see and a determination can be made if the emergency vehicle is not considered to be visible to the vehicle occupant of the vehicle 1.

In an example embodiment the surrounding information detection sensor is a camera 20a, and by knowing the vertical distance between the camera 20a and the eye height of the vehicle occupant the vehicular system can estimate if the driver's view is blocked, even if the camera's view is not blocked.

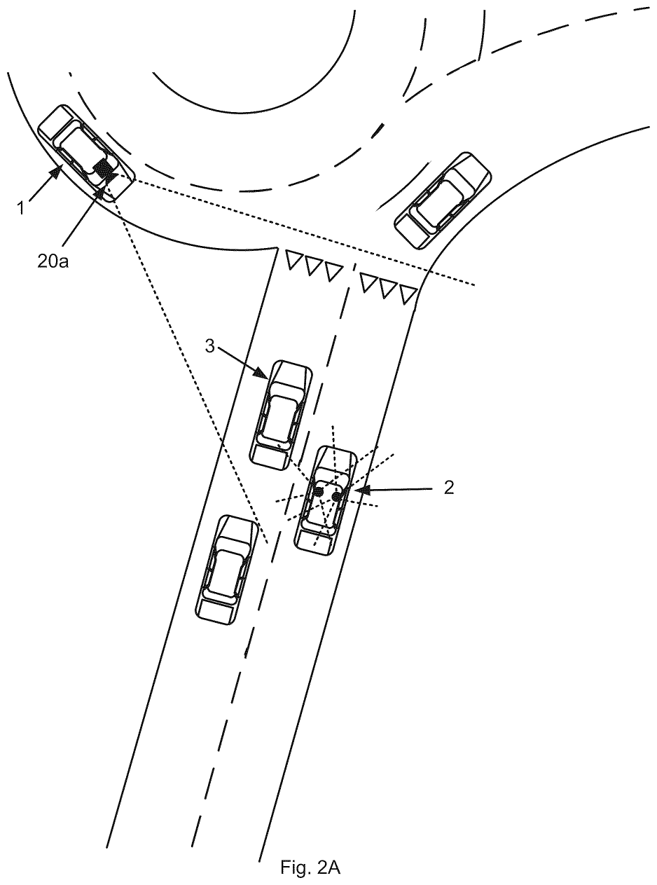

FIG. 2A illustrates an example wherein the surrounding information detection sensor is a camera and the surrounding information data is image data.

In the example illustration in FIG. 2A the blocking vehicle 3 makes it impossible for the vehicle occupant 5 of the vehicle 1 to see the emergency vehicle 2. By knowing the vertical distance between the camera 20a and the eye height of the vehicle occupant 5 the vehicular system 100 can estimate if the driver's view is blocked.

According to some embodiments, the surrounding information data is any of map data, road information data, emergency vehicle detection data and weather information data, and a determination can be made if the emergency vehicle is not considered to be visible to the vehicle occupant of the vehicle 1.

FIG. 2B illustrates an example wherein the surrounding information detection sensor is a wireless communication interface and the surrounding information data is at least any of map data, traffic information data, population density data, road information data, emergency vehicle detection data and weather information data.

FIG. 2B illustrates an example embodiment where the vehicle 1 is in a city environment and the emergency vehicle 2 is on a different road that intersects with the road that the vehicle 1 is on, and by using emergency vehicle detection data and map data, it is determined that there are buildings in the line of sight between the vehicle 1 and the emergency vehicle 2 and a determination is made that the emergency vehicle is not considered to be visible to the vehicle occupant 5 of the vehicle 1.

One advantage with this embodiment is that when it is determined that the emergency vehicle cannot be observed by the vehicle occupant 5, the vehicle occupant 5 will be notified of the emergency vehicle.

According to some embodiments the notification value is correlated with a cognitive load value, and wherein the processing circuitry 102a, 102b, 102c is further configured to determine a cognitive load value based on the obtained surrounding information data, wherein the cognitive load value is indicative of if the obtained surrounding information data is determined to have an impact on the perceptiveness of the vehicle occupant 5, and in a determination that the cognitive load value is above a predefined threshold level set the notification value to a value that is above the predefined threshold level.

One advantage with this embodiment is that when it is determined that the perceptiveness of the vehicle occupant is affected, the vehicle occupant will be notified of the emergency vehicle.

According to some embodiments the cognitive load value is determined based on surrounding information data of the surrounding external and/or internal to the vehicle 1.

According to some embodiments the cognitive load value is determined based on surrounding information data that is at least any of sound data, image data, traffic information data and weather information data.

According to some embodiments the cognitive load value is determined based on sound data, and in a determination that the sound data is indicative of a sound level that is above a predetermined threshold, it is determined that the vehicle occupant of the vehicle 1 will likely not hear the emergency vehicle 2, and determining a cognitive load value that is above the predefined threshold level.

In an example the cognitive load value is determined based on sound data of the surrounding external to the vehicle 1, and the sound level caused by heavy traffic and road construction work causes a sound level that is above the predetermined threshold.

In an example the cognitive load value is determined based on sound data of the surrounding internal to the vehicle 1, and the sound level caused by screaming children causes a sound level that is above the predetermined threshold.

According to some embodiments the cognitive load value is determined based on image data, and in a determination that the image data is indicative of a that the vehicle occupant 5 of the vehicle is gazing in a direction other than the direction of the detected emergency vehicle 2, determining a cognitive load value that is above the pre-defined threshold level.

According to some embodiments the surrounding information detection sensor is an eye tracking device and the image data is obtained by the eye tracking device.

According to some embodiments the cognitive load value is determined based on image data, and in a determination that the image data is indicative of a plurality of moving objects above a predetermined number of moving objects, determining a cognitive load value that is above the pre-defined threshold level.

In an example the cognitive load value is determined based on image data of the surrounding external to the vehicle 1, and the image data is indicative of plurality of humans moving around the vehicle 1.

According to some embodiments the cognitive load value is determined based on image data, and in a determination that the image data is indicative of a that the vehicle occupant 5 of the vehicle 1 has not gazed in the direction where the emergency vehicle 2 is detected in relation to the vehicle 1 within a predetermined time, determining a cognitive load value that is above the predefined threshold level.

According to some embodiments the cognitive load value is determined based on image data, and in a determination that the image data is indicative of a that the vehicle occupant 5 of the vehicle 1 is gazing in plurality of directions above a predetermined number of directions within a predetermined time period, determining a cognitive load value that is above the predefined threshold level.

According to some embodiments the cognitive load value is determined based on image data, and in a determination that the image data is indicative of that the behaviour of vehicle occupant of the vehicle is not normal, determining a cognitive load value that is above the predefined threshold level.

According to some embodiments the cognitive load value is determined based on image data, and in a determination that the image data is indicative of a that the vehicle occupant of the vehicle has gazed in the direction where the emergency vehicle 2 is detected in relation to the vehicle 1 within a predetermined time, determining a cognitive load value that is below the predefined threshold level.

One advantage with this embodiment is that surrounding information data of the surrounding external to the vehicle, e.g. heavy traffic, many pedestrians, and/or internal to the vehicle, e.g. noise inside of the vehicle, can be used to determine the cognitive load value.

According to some embodiments the system 100 further comprises an output interface 400a,400b for notifying the vehicle occupant 5 of the emergency vehicle 2 in the vicinity if the vehicle 1, wherein the output interface is any of a display output interface, a sound output interface, a tactile output interface, a light output interface.

One advantage with this embodiment is that the vehicle occupant can see, feel and/or hear the notification.

According to some embodiments the display output interface is any of a dashboard display, a head up display or a central user interface display.

According to some embodiments the sound output interface is a vehicle entertainment speaker system.

According to some embodiments the light output interface is a vehicle compartment light system.

According to some embodiments the processing circuitry 102a, 102b, 102c is further configured to notify the vehicle occupant 5 by a directional information notification indicative of a direction to the emergency vehicle 2 in relation to the vehicle 1.

According to some embodiments the output interface 400a,400b is used for notifying the vehicle occupant 5 of the directional information notification. According to some embodiments the directional information notification is any of a graphical indication, a light indication, a sound indication or a vibrating indication.

In an example, the directional information notification is a sound of an emergency vehicle played back in the vehicle entertainment speaker system with a directional effect to support the driver of the vehicle 1 to detect an emergency vehicle 2 in a certain direction. In an example the sound of an emergency vehicle comes from the front left of the vehicle, e.g. as in the situation as illustrated in FIGS. 1a and 1b.

In an example, the directional information notification is a light of an emergency vehicle e.g. flashing red and blue light, of the is a vehicle compartment light system with a directional effect to support the driver of the vehicle 1 to detect an emergency vehicle 2 in a certain direction.

In an example the flashing red and blue light comes from the front left compartment lights of the vehicle, e.g. as in the situation as illustrated in FIGS. 1a and 1b.

One advantage with this embodiment is that the vehicle occupant get support with finding the direction where the emergency vehicle can be found.

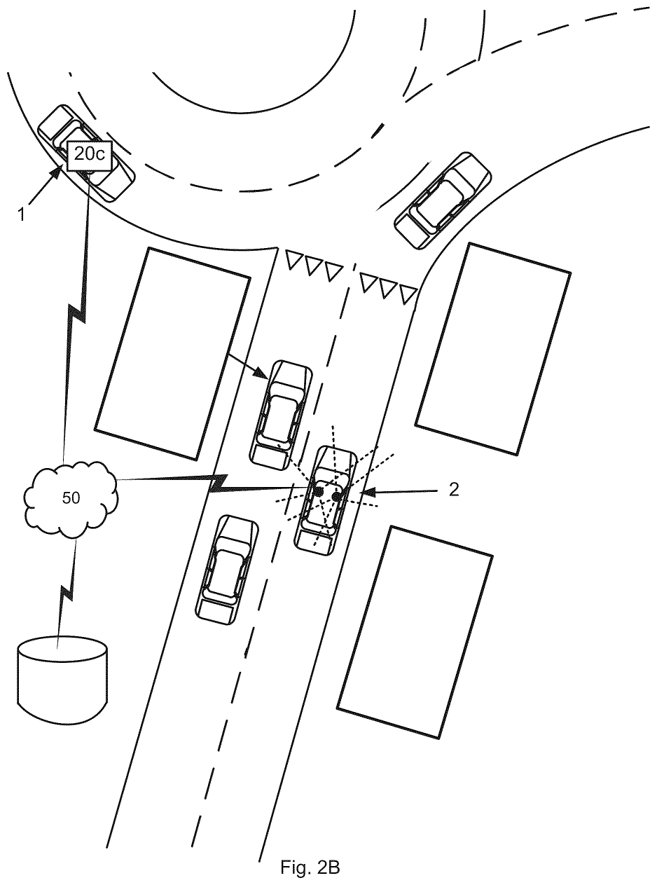

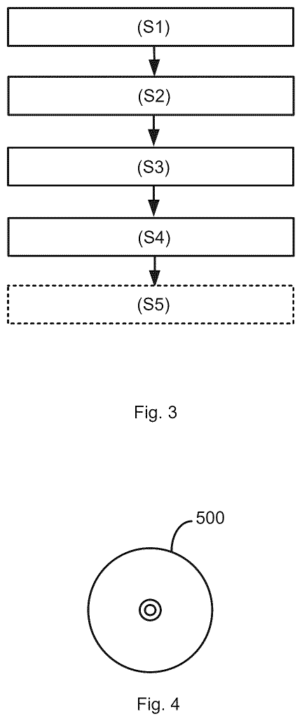

The second aspect of this disclosure shows a method for notifying a vehicle occupant 5 of a nearby emergency vehicle 2. FIG. 3 illustrates a flow chart of the method steps according to the second aspect of the disclosure.

The method comprising the step of S1 obtaining surrounding information data of the surrounding of the vehicle 1 and the vehicle occupant 5, the step of S2 detecting, based on the obtained surrounding information data, an emergency vehicle 2 in the vicinity of the vehicle 1, the step of S3 determining a notification value based on the obtained surrounding information data, and in a determination that the notification value is above a predefined threshold level the step of S4 notifying the vehicle occupant 5 of the emergency vehicle 2.

One advantage with this second aspect is that the vehicular system can be used for supporting the vehicle occupant to become aware of a nearby emergency vehicle when it is determined that the there is a need to notify the vehicle occupant of the emergency vehicle.

According to some embodiments the surrounding information data is at least any of sound data, image data, map data, traffic information data, population density data, road information data and weather information data.

One advantage with this embodiment is that different surrounding information data can be used for determining when to notify the vehicle occupant of the emergency vehicle.

According to some embodiments the obtained surrounding information data is indicative of that the vehicle 1 is in a city environment and setting the notification value to a value that is above the predefined threshold level.

In a city it is generally more information in the surroundings that the vehicle occupant needs to pay attention to compare to when the vehicle occupant is in a rural area.

One advantage with this embodiment is that if the vehicle is in a city environment the vehicle occupant will be notified of the emergency vehicle.

According to some embodiments the obtained surrounding information data is indicative of that emergency vehicle 2 is not visible to the vehicle occupant 5 of the vehicle 1 and setting the notification value to a value that is above the predefined threshold level.

One advantage with this embodiment is that when it is determined that the emergency vehicle cannot be observed by the vehicle occupant, the vehicle occupant will be notified of the emergency vehicle.

According to some embodiments wherein the notification value is correlated with a cognitive load value, and the method further the method comprises determining a cognitive load value based on the obtained surrounding information data, wherein the cognitive load value is indicative of if the obtained surrounding information data is determined to have an impact on the perceptiveness of the vehicle occupant 5, and in a determination that the cognitive load value is above a predefined threshold level setting the notification value to a value that is above the predefined threshold level.

One advantage with this embodiment is that when it is determined that the perceptiveness of the vehicle occupant is affected, the vehicle occupant will be notified of the emergency vehicle.

According to some embodiments the method further the method comprises the step of S5 notifying the vehicle occupant 5 by a directional information notification indicative of a direction to the emergency vehicle 2 in relation to the vehicle 1.

One advantage with this embodiment is that the vehicle occupant get support with finding the direction where the emergency vehicle can be found.

The third aspect of this disclosure shows a computer program product the second aspect comprising a non-transitory computer readable medium, having thereon a computer program comprising program instructions, the computer program being loadable into a processing circuitry 102a, 102b, 102c and configured to cause execution of the method when the computer program is run by the processing circuitry 102a, 102b, 102c.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claims, from a study of the drawings, the disclosure, and the appended claims.

What is claimed is:

1. A vehicular system for notifying a vehicle occupant of a vehicle of a nearby emergency vehicle, the system comprises:
a surrounding information detection sensor configured to obtain surrounding information data of the surrounding of the vehicle and the vehicle occupant; and
a processing circuitry configured to:
obtain surrounding information data of the surrounding of the vehicle and the vehicle occupant;
detect, based on the obtained surrounding information data, an emergency vehicle in the vicinity of the vehicle;
determine a notification value based on the obtained surrounding information data, and in a determination that the notification value is above a predefined threshold level
notify the vehicle occupant of the emergency vehicle.

2. The system according to claim 1, wherein the surrounding information data is at least any of sound data, image data, map data, traffic information data, population density data, road information data, emergency vehicle detection data and weather information data.

3. The system according to claim 1, wherein the obtained surrounding information data is indicative of that the vehicle is in a city environment and setting the notification value to a value that is above the predefined threshold level.

4. The system according to claim 1, wherein the obtained surrounding information data is indicative of that the emergency vehicle is not visible to the vehicle occupant of the vehicle and setting the notification value to a value that is above the predefined threshold level.

5. The system according to claim 1, wherein the notification value is correlated with a cognitive load value, and wherein the processing circuitry is further configured to:
determine a cognitive load value based on the obtained surrounding information data, wherein the cognitive load value is indicative of if the obtained surrounding information data is determined to have an impact on the perceptiveness of the vehicle occupant, and in a determination that the cognitive load value is above a predefined threshold level
set the notification value to a value that is above the predefined threshold level.

6. The system according to claim 5, wherein the cognitive load value is determined based on surrounding information data of the surrounding external and/or internal to the vehicle.

7. The system according to claim 1, the system further comprises
an output interface for notifying the vehicle occupant of the emergency vehicle in the vicinity if the vehicle, wherein the output interface is any of a display output interface, a sound output interface, a tactile output interface, a light output interface.

8. The system according to claim 1, wherein the processing circuitry is further configured to:
notify the vehicle occupant by a directional information notification indicative of a direction to the emergency vehicle in relation to the vehicle.

9. A method for notifying a vehicle occupant of a nearby emergency vehicle, the method comprising:
obtaining surrounding information data of the surrounding of the vehicle and the vehicle occupant;
detecting, based on the obtained surrounding information data, an emergency vehicle in the vicinity of the vehicle;
determining a notification value based on the obtained surrounding information data, and in a determination that the notification value is above a predefined threshold level
notifying the vehicle occupant of the emergency vehicle.

10. The method according to claim 9 wherein the surrounding information data is at least any of sound data, image data, map data, traffic information data, population density data, road information data and weather information data.

11. The method according to claim 9, wherein the obtained surrounding information data is indicative of that the vehicle is in a city environment and setting the notification value to a value that is above the predefined threshold level.

12. The method according to claim 9, wherein the obtained surrounding information data is indicative of that emergency vehicle is not visible to the vehicle occupant of the vehicle and setting the notification value to a value that is above the predefined threshold level.

13. The method according to claim 9, wherein the notification value is correlated with a cognitive load value, and the method further comprising:
determining a cognitive load value based on the obtained surrounding information data, wherein the cognitive load value is indicative of if the obtained surrounding information data is determined to have an impact on the perceptiveness of the vehicle occupant, and in a determination that the cognitive load value is above a predefined threshold level setting the notification value to a value that is above the predefined threshold level.

14. The method according to claim 9, the method further comprising:
notifying the vehicle occupant by a directional information notification indicative of a direction to the emergency vehicle in relation to the vehicle.

15. A computer program product comprising a non-transitory computer readable medium, having stored thereon a computer program comprising program instructions, the computer program being loadable into a processing circuitry and configured to cause execution of the method according to claim 9 when the computer program is run by the processing circuitry.
